(19) United States
(12) Patent Application Publication
(10) Pub. No.: US 2025/0181939 A1
(43) Pub. Date: Jun. 5, 2025

(54) TECHNIQUES FOR AUTOMATICALLY GENERATING ON-DEMAND ANSWERS TO QUESTIONS ABOUT SOFTWARE APPLICATIONS FEATURED IN LEARNING VIDEOS

(71) Applicant: AUTODESK, INC., San Francisco, CA (US)

(72) Inventors: Saelyne YANG, Daejeon (KR); Jo Karel VERMEULEN, East York (CA); George William FITZMAURICE, Toronto (CA); Justin Frank MATEJKA, Newmarket (CA)

(21) Appl. No.: 18/965,766

(22) Filed: Dec. 2, 2024

Related U.S. Application Data
(60) Provisional application No. 63/606,052, filed on Dec. 4, 2023.

(51) Int. Cl. G06N 5/04

(52) U.S. Cl. CPC G06N 5/04

(57) ABSTRACT

One embodiment sets forth a technique for generating answers to questions about a software application that is featured in a learning video. According to some embodiments, the technique includes the steps of (1) generating at least one description based on at least one image-based input associated with the learning video, (2) generating a combined value based on the at least one description and a text-based question, (3) obtaining a plurality of articles based on the combined value, (4) generating, via at least one generative artificial intelligence (AI) model, an answer to the text-based question based on the plurality of articles, and (5) causing at least a portion of the answer to be output via at least one user interface.

### CROSS-REFERENCE TO RELATED APPLICATIONS

The present application claims the benefit of U.S. Provisional Application titled, “AUTOMATED QUESTION-ANSWERING IN TUTORIAL VIDEOS WITH VISUAL ANCHORS,” filed on Dec. 4, 2023, and having Ser. No. 63/606,052. The subject matter of this related application is hereby incorporated herein by reference.

### BACKGROUND

### Field of the Various Embodiments

Embodiments of the present disclosure relate generally to computer science, artificial intelligence, and complex software applications, and, more specifically, to techniques for automatically generating on-demand answers to questions about software applications featured in learning videos.

### Description of the Related Art

Learning from videos for feature-rich software applications presents a range of technical challenges for users that make resolving questions as users watch the learning videos difficult. In particular, learning videos function as a one-way communication medium, where an instructor explains processes without the ability for the user to engage directly or ask questions in real-time. This lack of interaction establishes a learning barrier, especially when users encounter specific questions or require clarification on certain steps that are being discussed in learning videos. Because the learning video format does not allow for immediate answers to be provided, users typically have to rely on external comment sections or forums to get questions answered, where responses can take hours or even days to receive. These types of delays interrupt the learning flow and oftentimes cause users to move forward with using the software without fully understanding a concept, or to abandon the tutorial altogether.

Another technical limitation of conventional video tutorial platforms lies in the lack of contextualized questioning. In particular, most conventional learning video platforms do not allow questions and answers to be directly linked to particular points in the learning video. Consequently, users oftentimes have to describe questions in vague terms or reference timestamps when asking questions, which can be cumbersome and can lead to misunderstandings. Without the ability to ask questions tied to exact moments or steps in learning videos, fully understanding and addressing the issues being raised in questions becomes more challenging for other users or publishers of the learning videos. Consequently, the clarity and utility of the answers received by users can be reduced because the answers may not directly address the specific user needs underlying the questions.

The decentralized nature of user questions presents another challenge for learning video users. In particular, video tutorial platforms generally lack a unified system where all questions and responses are aggregated or organized in a way that benefits users. As a result, users oftentimes have to find answers to questions scattered across comment threads or in external forums, but such an approach constitutes a fragmented and inefficient way to access helpful information. This dispersed nature of question/answer management imposes additional time and effort on users and detracts from the overall learning experience.

Finally, the sheer volume of users asking questions can overwhelm the comment sections and other support mechanisms available on conventional video tutorial platforms. In particular, user questions and comments can accumulate quickly, especially for learning videos associated with popular software applications. The influx of user questions and comments can result in individual questions being overlooked or buried under newer questions or comments. The lack of a prioritized or a structured response system can yield a disorganized environment where only a fraction of users receive answers or helpful feedback, while the remaining users are left struggling through the learning videos without sufficient support. This limitation is particularly challenging for beginner users, who may require more guidance and clarification when learning how to use a feature-rich software application.

As the foregoing illustrates, what is needed in the art are more effective techniques for implementing learning video environments.

### SUMMARY

One embodiment sets forth a computer-implemented method for generating answers to questions about a software application that is featured in a learning video. According to some embodiments, the method includes the steps of (1) generating at least one description based on at least one image-based input associated with the learning video, (2) generating a combined value based on the at least one description and a text-based question, (3) obtaining a plurality of articles based on the combined value, (4) generating, via at least one generative artificial intelligence (AI) model, an answer to the text-based question based on the plurality of articles, and (5) causing at least a portion of the answer to be output via at least one user interface.

Other embodiments of the present disclosure include, without limitation, one or more computer-readable media including instructions for performing one or more aspects of the disclosed techniques as well as a computing device for performing one or more aspects of the disclosed techniques.

One technical advantage of the disclosed techniques over the prior art is that the disclosed techniques provide an efficient system for providing automated and contextualized assistance to users when interacting with learning videos. In particular, by enabling the user to select different user interface elements of a software application featured in a learning video—such as icons, menu items, or other visual components—the disclosed techniques can be implemented to identify and interpret the selected user interface elements by looking up the selected elements in a library of known user interface elements that are specific to the software application. This automated recognition allows the system to generate descriptions of the selected user interface elements that are contextualized to the software application.

In addition, once the system has generated the contextualized descriptions, the system can pair the contextualized description with one or more questions input by the user. Once paired, the disclosed techniques enable a wide array of internal and external resources, such as documentation, transcriptions of learning videos, and related knowledge bases, to be searched for relevant information. This automated linking of contextualized descriptions and questions to specific resources helps ensure that users receive relevant guidance that is directly applicable to the questions asked. Further, with the disclosed techniques, relevant responses and information can be returned to users more immediately relative to what can be achieved using prior art approaches, thereby facilitating a more real-time learning experience for users.

Yet another technical advantage is that the disclosed techniques enable scaling to accommodate a high volume of queries, thereby enabling a more personalized support experience for all users relative to what is typically experienced with prior art approaches. Moreover, by enabling the libraries of icons, menu items, and other visual elements associated with a software application to be continuously updated, the disclosed techniques allow a video tutorial platform to remain current with any changes that are made to software applications over time, thereby enabling the platform to maintain ongoing relevance and accuracy when providing answers to questions.

These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure configured to implement one or more aspects of various embodiments.

FIG. 2 is a conceptual illustration of an architecture and an informational flow that can be implemented by the management server of FIG. 1, according to various embodiments.

FIGS. 3A-3H illustrate conceptual diagrams of a user interface associated with a software application executing on one of the endpoint devices of FIG. 1, according to various embodiments.

FIG. 4 illustrates a method for automatically generating answers to user questions about a software application that is featured in a learning video, according to various embodiments.

FIG. 5 is a more detailed illustration of a computing device that can implement the functionalities of the entities illustrated in FIG. 1, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

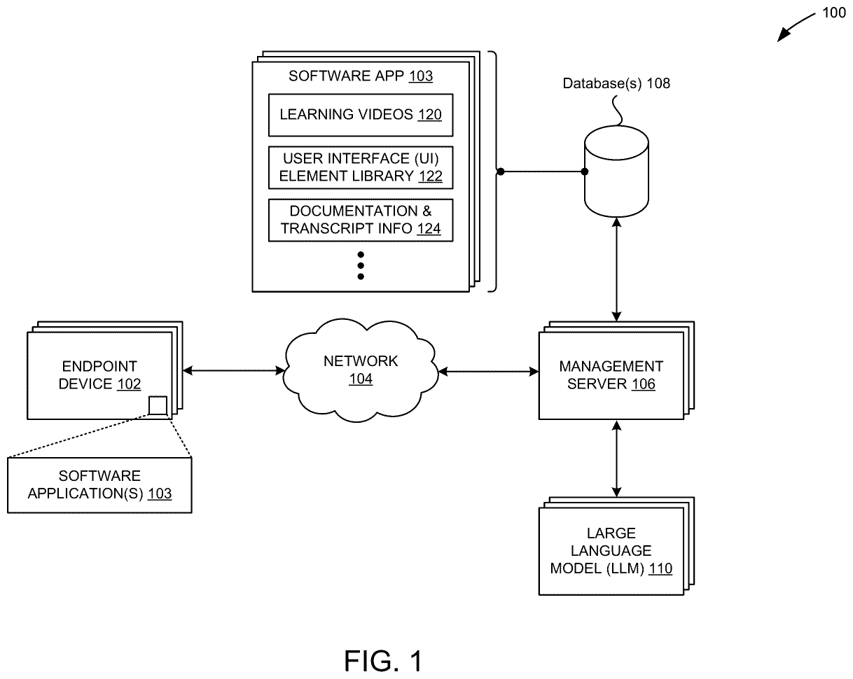

FIG. 1 is a conceptual illustration of a system 100 configured to implement one or more aspects of the various embodiments. As shown, the system 100 includes at least one endpoint device 102, at least one management server 106, at least one database 108, and at least one large language model 110, each of which are connected via a communications network 104. The communications network 104 can represent, for example, any technically feasible network or number of networks, including a wide area network (WAN) such as the Internet, a local area network (LAN), a Wi-Fi network, a cellular network, or a combination thereof.

The endpoint device 102 can represent a computing device (e.g., a desktop computing device, a laptop computing device, a mobile computing device, etc.). As shown in FIG. 1, at least one software application 103 can be installed and execute on the endpoint device 102. The software application 103 can represent, for example, a web browser application, a web browser application extension, a productivity application, and the like. The software application 103 can interface with the management server 106 to access and play back learning videos 120 that are managed by the management server 106 (and/or other entities not illustrated in FIG. 1).

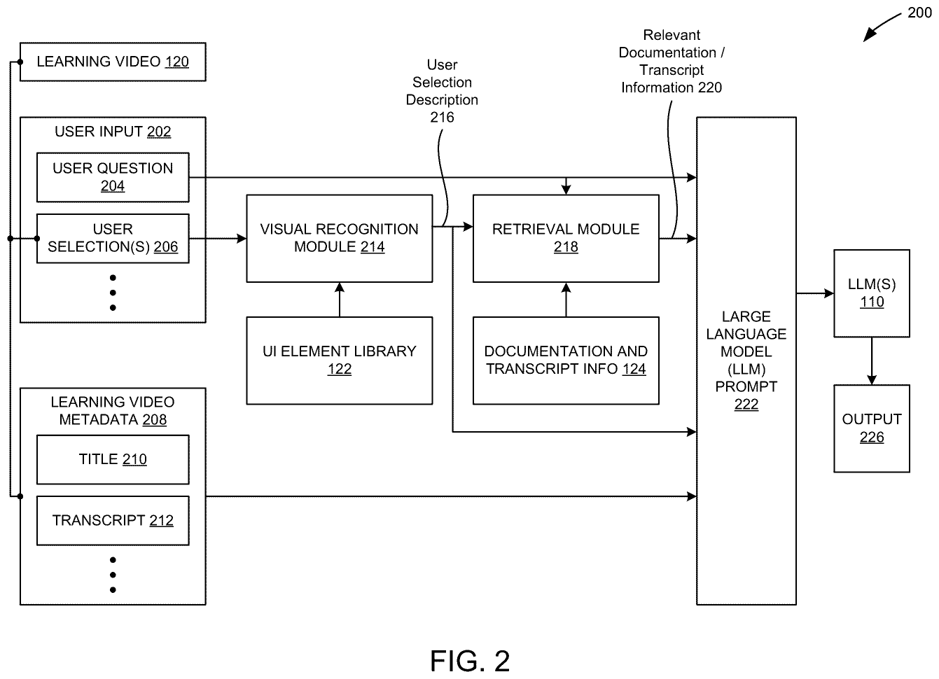

During playback of the learning video 120, the software application 103 can enable a user to input (e.g., using voice-based inputs, text-based inputs, etc.) a question that is relevant to the learning video 120 and to which the user is seeking an answer. The software application 103 can also enable the user to select portions (e.g., screenshots, snippets, etc.) of the learning video 120 that are relevant to the aforementioned question. The software application 103 can provide the question and the selected portions to the management server 106 for analysis. In turn, the software application 103 can receive the answer from the management server 106 and output (e.g., display, read out, etc.) the answer. A more detailed explanation of the functionality of the software application 103 is provided below in conjunction with FIGS. 2-4.

The management server 106 can represent a computing device (e.g., a rack server, a blade server, a tower server, etc.). As shown in FIG. 1, the management server 106 can interface with one or more databases 108 that are implemented by the management server 106 (and/or other entities not illustrated in FIG. 1). The databases 108 can include, for at least one software application 103, one or more learning videos 120 associated with the software application 103, a user interface (UI) element library 122 associated with the software application 103, documentation and transcript information 124 associated with the software application 103 (and other information associated with the software application 103), the details of which are described below in greater detail in conjunction with FIGS. 2-4.

As described above, the management server 106 can be configured to provide (e.g., stream, download to, etc.) a learning video 120 to a software application 103 executing on an endpoint device 102. As also described above, the management server 106 can be configured to receive, from the software application 103, a request for an answer to a question, where the request includes selection portions of the learning video. In response, the management server 106 can perform different analyses, e.g., using the databases 108, one or more large language models 108, etc., to generate the answer for the question. The management server 106 can provide the answer back to the software application 103, which can then be displayed to the user. A more detailed explanation of the functionality of the management server 106 is provided below in conjunction with FIGS. 2-4.

It will be appreciated that the endpoint device 102, the management server 106, the database 108, and the large language model 108 described in conjunction with FIG. 1 are illustrative, and that variations and modifications are possible. The connection topologies, including the number of CPUs and memories, may be modified as desired, and, in certain embodiments, one or more components shown in FIG. 1 not be present, or may be combined into fewer components. Further, in certain embodiments, one or more components shown in FIG. 1 may be implemented as virtualized resources in one or more virtual computing environments and/or cloud computing environments.

### Automatically Generating On-Demand Answers to Questions

FIG. 2 is a conceptual illustration of an architecture and an informational flow that can be implemented by the management server 106 of FIG. 1, according to various embodiments. As shown in FIG. 2, the management server 106 can receive, from a software application 103 executing on an endpoint device 102, a user input 202 that includes a user question 204. The user question 204 can be relevant to a learning video 120 that is being played back on the endpoint device 102, and can take the form of text-based input, spoken audio input that is converted into text-based input, and so on. As shown in FIG. 2, the user input 202 can also include at least one user selection 206 associated with the learning video 120. For example, the user selection 206 can correspond to a selected area of the learning video 120, such as a screenshot of a frame of the learning video, a portion of a screenshot of a frame of the learning video (e.g., selected using a bounding box tool), and the like. The user selection 206 can alternatively correspond to a video sequence (i.e., two or more frames, or portions thereof, of the learning video 120). It is noted that the foregoing examples are not meant to be limiting, and that the user input 202 can include any amount, type, form, etc., of information, at any level of granularity, consistent with the scope of this disclosure.

As shown in FIG. 2, the management server 106 can implement a visual recognition module 214 that receives the user selection 206 as an input and then outputs a description of the user selection 206. The user selection 206 can capture, for example, a UI element of the software application 103, a workspace of the software application 103, an annotation in the learning video 120 (e.g., an overlay), and/or other miscellaneous information included in the learning video 120. The visual recognition module 214 can carry out a number of approaches to generate a description of the user selection 206 that is both accurate and contextual to the software application 103 associated with the learning video 120.

According to some embodiments, the visual recognition module 214 can implement an image captioning module that combines computer vision and natural language processing to generate descriptive text for images using the following example procedures. First, a convolutional neural network (CNN) can process the image to extract visual features, creating a compressed representation that captures objects, shapes, colors, and spatial relationships. These features can then be passed to a recurrent neural network (RNN), a transformer-based model, etc., which generates a text-based description based on learned patterns in image-caption pairs from training data. For example, if the image captioning module processes an image of a user interface icon showing a magnifying glass—which commonly represents a search feature offered by a software application—then the image captioning module might detect circular and handle-like shapes that resemble a magnifying glass. The image captioning module can then interpret these features and output a description, e.g., “search icon” or “magnifying glass symbol representing search”. By identifying visual cues and aligning them with common meanings, the image captioning model can produce relevant captions that can be used to contextualize the user input 202 to the software application 103.

The visual recognition module 214 can also implement a UI element detection module that compares the user selection 206 against the UI element library 122 associated with the software application 103. As a brief aside, the UI element library 122 can be generated using a variety of approaches. For example, the documentation information (and/or other information) included in the documentation information 124 associated with the software application 103 can be crawled, analyzed, etc., to identify individual images of UI elements of the endpoint software application 103 and descriptive information associated with the UI elements (e.g., names, functionality descriptions), and so on. In turn, the UI element library 122 can be used to store an entry for each UI element, where the entry includes an image of the UI element and the corresponding descriptive information. In this manner, the UI element detection module can effectively match the user selection 206 to an entry within the UI element library 122, and extract the descriptive information stored within the entry. In turn, the descriptive information can be used to further-contextualize the user input 202 to the software application 103.

It will be appreciated that various approaches can be used to effectively identify one or more entries in the UI element library 122 that correspond to the user selection 206. For example, if the dimensions of the user selection 206 exceed a certain threshold (e.g., 100 pixels in width and height), then the visual recognition module 214 can perform an initial UI element detection procedure that involves identifying whether two or more UI elements are included in the user selection 206. For example, one or more models can be utilized to generate bounding boxes around each UI element that is detected in the user selection 206. In turn, the visual recognition module 214 can apply an image similarity algorithm to the image content included in each bounding box to identify the corresponding image(s), if any, included in the UI element library 122. For example, the UI element library 122 can implement real-time computer vision algorithms to extract and compare features between the image content and the images stored in the UI element library 122, and establish similarity scores. Matching entries found within the UI element library 122 can then be filtered based on the similarity score associated with each match (e.g., entries having similarity scores that do not satisfy a threshold level of similarity can be disregarded).

Additionally, the visual recognition module 214 can implement an optical character recognition (OCR) module that outputs text-based information that is included in the user selection 206 using the following example procedures. First, the OCR module can process the user selection 206 by enhancing readability through grayscale conversion, noise reduction, and contrast adjustments. The OCR module can then segment the user selection 206 into distinct regions, and identify areas likely to contain text. Using convolutional neural networks (CNNs), long short-term memory (LSTM) networks, etc., the OCR module can recognize characters based on pixel patterns, and then assemble them into words. Positional data can also be captured to allowing for each word to be linked to its specific location in the user selection 206. For instance, when analyzing an image of a dropdown menu labeled “File” with items like “New,” “Open,” and “Save,” the OCR module can output the detected words alongside positional coordinates. In this manner, the positional coordinates can be used to determine the order in which the items are disposed within the dropdown menu, thereby enabling digital reconstructions of the dropdown menu. In turn, the extracted words can be used to further-contextualize the user input 202 to the software application 103.

As shown in FIG. 2, the visual recognition module 214 combines the outputs generated by at least one of the image captioning module, the UI element detection module, or the OCR module, to generate a user selection description 216. For example, the visual recognition module 214 can apply different weights to the outputs, as well as instructions, to a large language model 110 to cause the large language model 110 to output the user selection description 216.

According to some embodiments, a retrieval module 218 implemented by the management server 106 can implement one or more machine learning models. In this regard, the retrieval module 218 can receive input information, which can include the user selection description 216, the user question 204 included in the user input 202, and any other relevant information. In response, the retrieval module 218 can identify information included in the documentation and transcript information 124 that is relevant to the user selection description 216. The documentation information can include, for example, user guide information associated with the software application 103, tutorial articles associated with the software application 103, and the like. The transcript information can include, for example, a text-based representation of words spoken in the learning videos 120, captions included in the learning videos 120, comments posted to the learning videos 120, and the like. It is noted that the foregoing examples are not meant to be limiting, and that the documentation and transcript information 124 and the transcript information can include any amount, type, form, etc., of information associated with the software application 103, at any level of granularity, consistent with the scope of this disclosure.

As a brief aside, when the documentation and transcript information 124 is initially ingested, processed, etc., the management server 106 can carry out a number of operations to enable the large language model 110 to analyze the full scope of the documentation and transcript information 124 when processing the user input 202. According to some embodiments, the information included in the documentation and transcript information 124 can be segmented into a number of chunks equal to the maximum token length accepted by the large language model 110. In turn, one or more embedding models can be used to generate embeddings for the chunks. In this manner, the large language model 110 can effectively and efficiently consider the documentation and transcript information 124 in its entirety when extracting information from the documentation and transcript information 124 that is relevant to the user input 202. It should be appreciated that different chunking/embedding approaches can be used to balance the speed, accuracy, etc., by which the large language model 110 is able to extract information from the documentation and transcript information 124.

Accordingly, the retrieval module 218 gathers, based on the user question 204 and the user selection description 216, relevant documentation/transcript information 220 from among the documentation and transcript information 124. Information within the relevant documentation/transcript information 220 can be assigned similarity scores so that any information that fails to satisfy a similarity threshold can be removed from the documentation/transcript information 220.

As shown in FIG. 2, the management server 106 can generate a large language model prompt 222 based on the user question 204, the user selection description 216, and the documentation/transcript information 220. Additionally, the management server 106 can generate the large language model prompt 222 based on learning video metadata 208, which can include, for example, a title 210 of the learning video 120, transcript information 212 for the learning video 120, description information for the learning video 120, and/or other information associated with the learning video 120. The transcript information 212 can include, for example, a description of the learning video 120, a text-based representation of words spoken in the learning video 120, captions included in the learning video 120, comments posted to the learning video 120, and the like. It will be appreciated that the management server 106 can implement any number, type, form, etc., of machine learning model(s), to effectively combine, modify, etc., the user question 204, the user selection description 216, the relevant documentation/transcript information 220, and the learning video metadata 208, and/or other relevant information to produce the large language model prompt 222, consistent with the scope of this disclosure.

As shown in FIG. 2, the large language model prompt 222 can be provided to one or more of the large language models 110. As described herein, the large language model prompt 222 includes a variety of information that enables the large language model prompt 222 to generate output 226 that addresses the user question 204 within the context of the software application 103. In particular, the large language model prompt 222 can include the user question 204 itself, a description of the user selection description 216 that is contextualized to the software application 103, relevant documentation/transcript information 220 that is contextualized to the user question 204 and the documentation information 124, and/or learning video metadata 208 that is specific to the learning video 120 being accessed by the user. In this regard, the large language model 110 is capable of generating an output 226 that is contextualized to the user question 204, the user selection 206, and the learning video 120. The management server 106 can then provide, to the software application 103, the output 226, to cause the software application 103 to display, output, etc., at least a portion of the output 226.

According to some embodiments, the output 226 can include different types of information to enhance the overall utility of the output 226. In one example, the output 226 can include one or more text-based answers to the user question 204, one or more audio-based answers to the user question 204, one or more video-based answers to the user question 204 (e.g., one or more animations, simulations, other relevant learning videos 120, etc.), and so on. In another example, the output 226 can include one or more images, videos, etc., that are interleaved into different areas of the one or more text-based answers. In another example, the output 226 can include information for one or more overlays to be displayed relative to the learning video 120 (e.g., positional information, caption information, etc.). In yet another example, the output 226 can include instructions that can be executed by the endpoint device 102, the software application 103, etc., to cause one or more actions to automatically be performed on the endpoint device 102. It is noted that the foregoing examples are not meant to be limiting, and that the output 226 can include any amount, type, form, etc., of information, at any level of granularity, consistent with the scope of this disclosure.

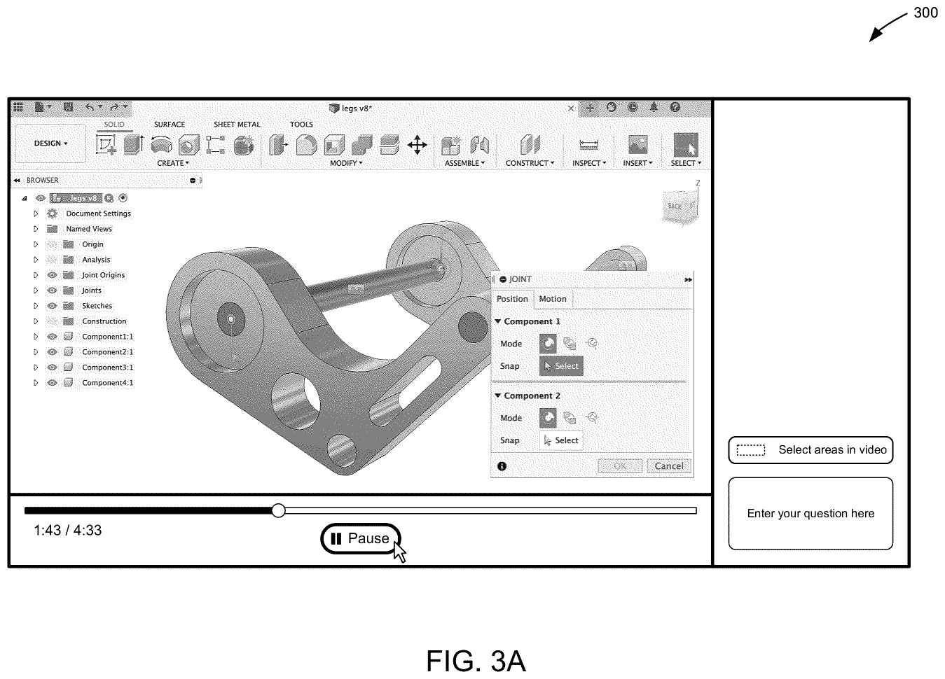

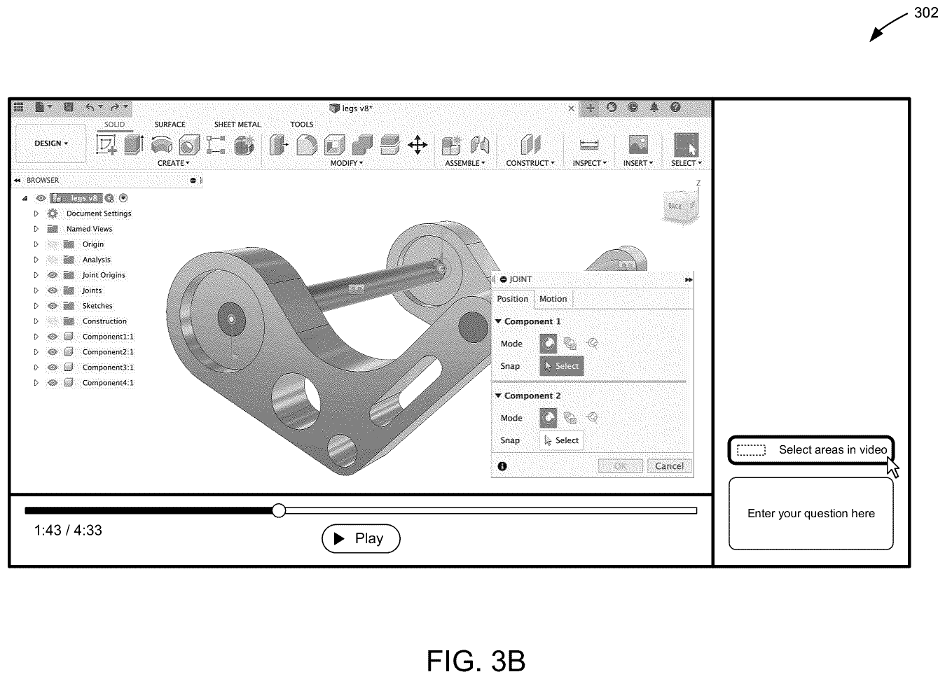

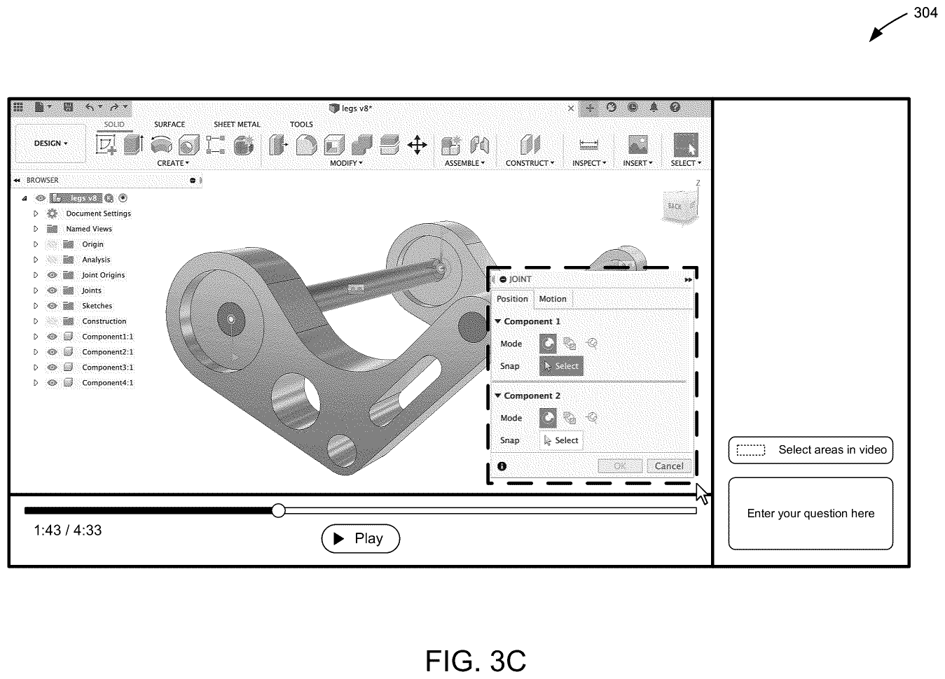

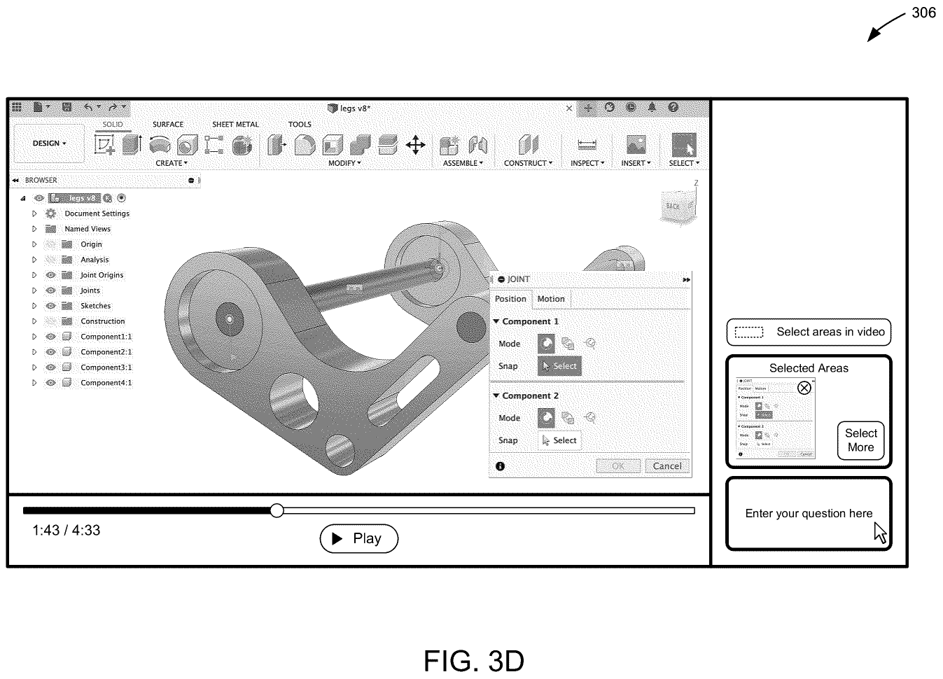

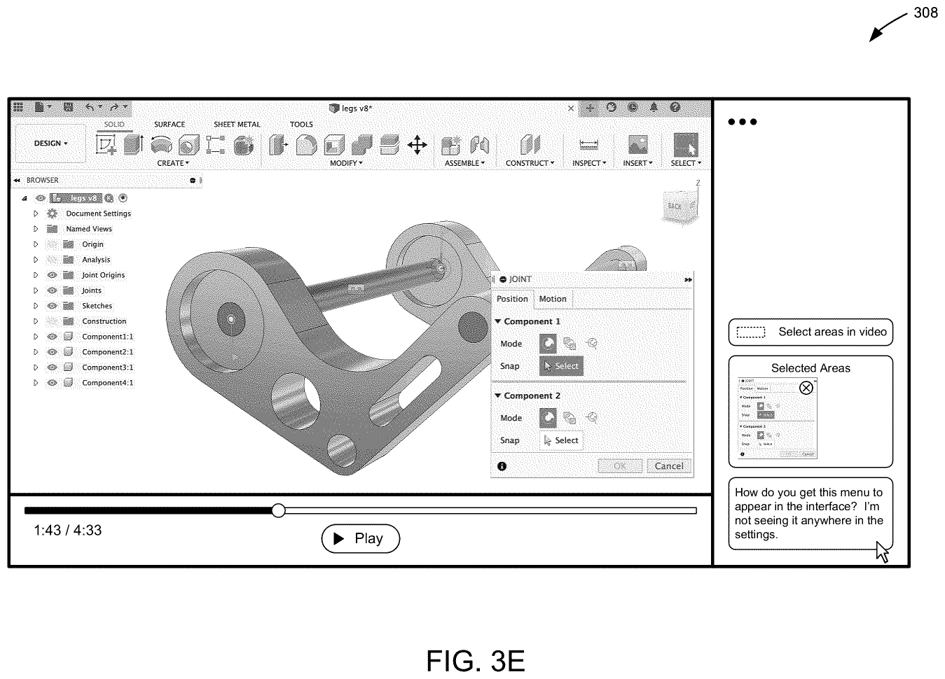

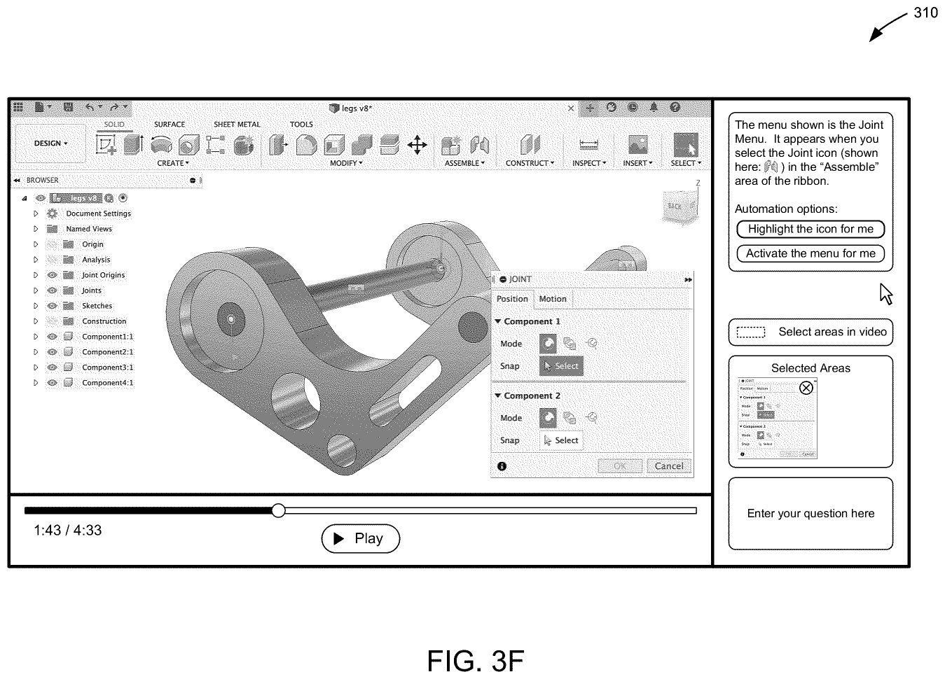

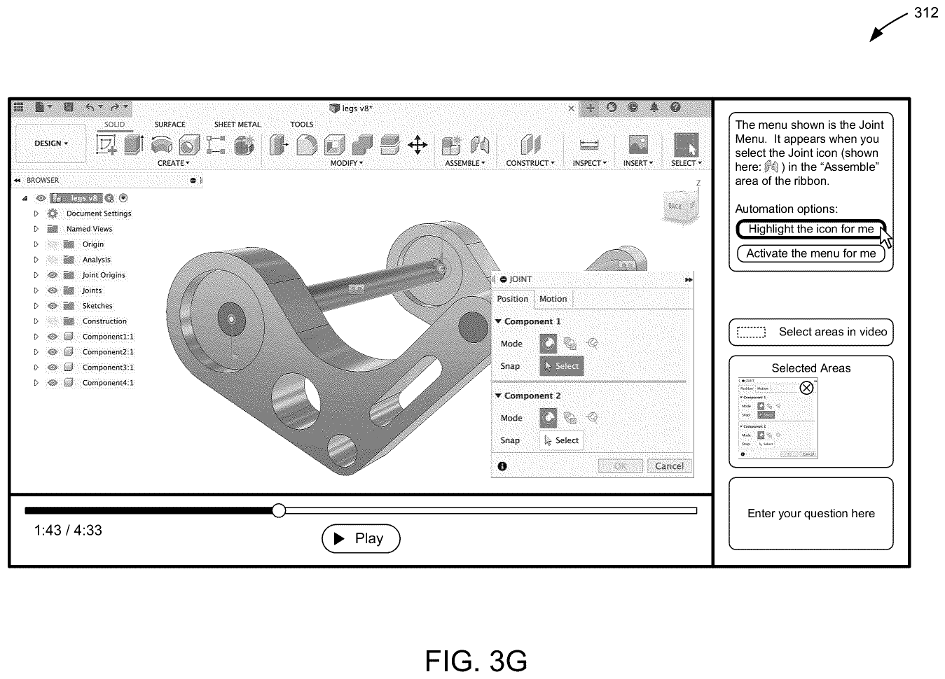

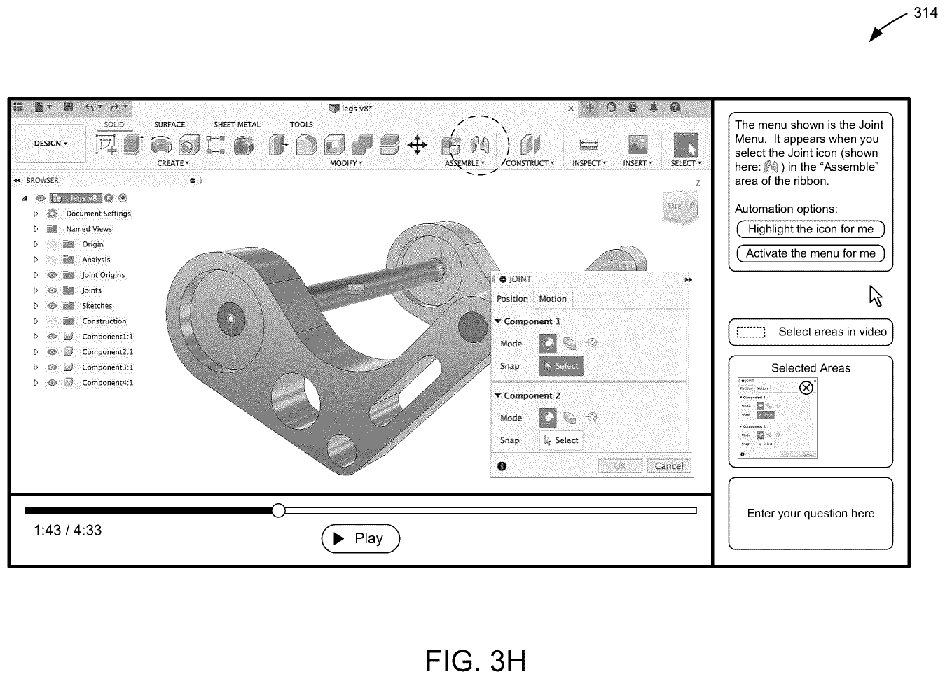

FIGS. 3A-3H illustrate conceptual diagrams of a user interface associated with a software application 103 executing on one of the endpoint devices 102 of FIG. 1, according to various embodiments. As shown in FIG. 3A, the user interface includes a video playback window for a learning video 120, where the video playback window includes UI elements that enable the user to control the playback of a learning video 120. In the example illustrated at a step 302 in FIG. 3A, the user has paused the playback of the learning video 120 due to an interest in an overlayed UI element with the title “Joint”. As also shown in FIG. 3A, the user interface includes a chat window that enables the user to select different areas in the learning video 120, as well as enter (e.g., type, speak, etc.) questions for which the user seeks answers.

Turning to FIG. 3B, a step 302 involves the user choosing the option to select different areas in the learning video 120. Turning to FIG. 3C, a step 304 involves the user drawing a bounding box around the aforementioned overlaid UI element with the title “Joint”. Turning to FIG. 3D, a step 306 involves the user completing their drawing of the bounding box. As shown in FIG. 3D, the chat window is populated with a “Selected Areas” window that includes a visual representation of the area of the learning video 120 selected by the user. The “Selected Areas” window also enables the user to select additional areas of the learning video 120, manage (e.g., delete) selected areas of the learning video 120, and so on. As shown in FIG. 3D, the user selects the option to enter a question. Turning to FIG. 3E, a step 308 involves the user typing and submitting the question “How do you get this menu item to appear in the interface? I'm not seeing it anywhere in the settings.” In turn, the user interface can be updated with an ellipsis to indicate that the question is being processed.

Turning to FIG. 3F, a step 310 involves updating the chat window when the software application 103 receives a response. As shown in FIG. 3F, the chat window includes a feature-rich answer that includes text (i.e., “The menu shown is the Joint Menu. It appears when you select the Joint icon (shown here: ) in the “Assemble” area of the ribbon.”), images (i.e., an image of the Joint icon), and actionable items (i.e., (1) an option to highlight where the icon is located in the learning video 120 and/or the software application 103 associated with learning video 120 corresponds, and (2) an option to activate the menu item within the software application 103). As shown in FIG. 3G, a step 312 involves the user selecting the highlight option, and, as shown at a step 314 in FIG. 3H, a highlight overlay is applied to location within the learning video 120 where the icon is disposed.

It is noted that the user interfaces illustrated in FIGS. 3A-3H are not meant to be limiting, and that the user interfaces can include any amount, type, form, etc., of UI element(s), at any level of granularity, consistent with the scope of this disclosure.

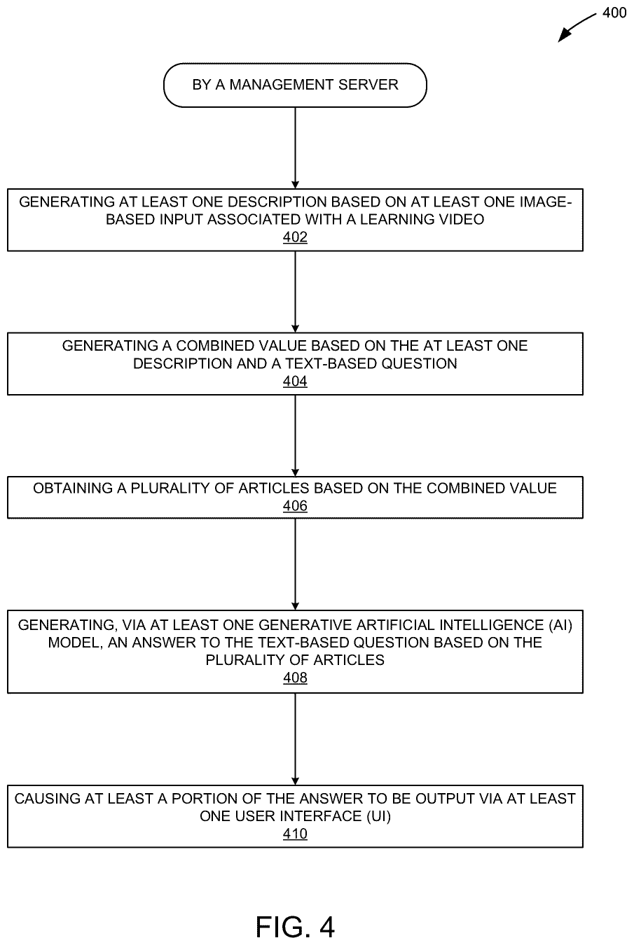

FIG. 4 illustrates a method for automatically generating answers to user questions about a software application 103 that is featured in a learning video, according to various embodiments. As shown in FIG. 4, the method 400 begins at step 402, where the management server 106 generates at least one description based on at least one image-based input associated with the learning video (e.g., as described above in conjunction with FIGS. 1-3).

At step 404, the management server 106 generates a combined value based on the at least one description and a text-based question (e.g., as described above in conjunction with FIGS. 1-3). At step 406, the management server 106 obtains a plurality of articles based on the combined value (e.g., as described above in conjunction with FIGS. 1-3).

At step 408, the management server 106 generates, via at least one generative artificial intelligence (AI) model, an answer to the text-based question based on the plurality of articles (e.g., as described above in conjunction with FIGS. 1-3). At step 410, the management server 106 causes at least a portion of the answer to be output via at least one user interface (e.g., as described above in conjunction with FIGS. 1-3).

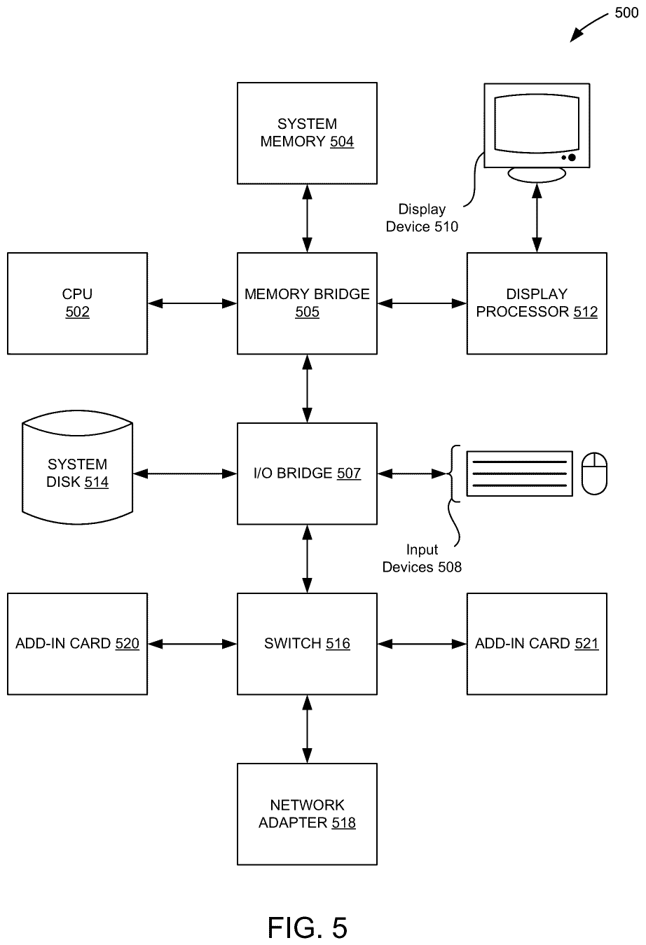

FIG. 5 is a more detailed illustration of a computing device that can implement the functionalities of the entities illustrated in FIG. 1, according to various embodiments. This figure in no way limits or is intended to limit the scope of the various embodiments. In various implementations, system 500 may be an augmented reality, virtual reality, or mixed reality system or device, a personal computer, video game console, personal digital assistant, mobile phone, mobile device or any other device suitable for practicing the various embodiments. Further, in various embodiments, any combination of two or more systems 500 may be coupled together to practice one or more aspects of the various embodiments.

As shown, system 500 includes a central processing unit (CPU) 502 and a system memory 504 communicating via a bus path that may include a memory bridge 505. CPU 502 includes one or more processing cores, and, in operation, CPU 502 is the master processor of system 500, controlling and coordinating operations of other system components. System memory 504 stores software applications and data for use by CPU 502. CPU 502 runs software applications and optionally an operating system. Memory bridge 505, which may be, e.g., a Northbridge chip, is connected via a bus or other communication path (e.g., a HyperTransport link) to an I/O (input/output) bridge 507. I/O bridge 507, which may be, e.g., a Southbridge chip, receives user input from one or more user input devices 508 (e.g., keyboard, mouse, joystick, digitizer tablets, touch pads, touch screens, still or video cameras, motion sensors, and/or microphones) and forwards the input to CPU 502 via memory bridge 505.

A display processor 512 is coupled to memory bridge 505 via a bus or other communication path (e.g., a PCI Express, Accelerated Graphics Port, or HyperTransport link); in one embodiment display processor 512 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 504.

Display processor 512 periodically delivers pixels to a display device 510 (e.g., a screen or conventional CRT, plasma, OLED, SED or LCD based monitor or television). Additionally, display processor 512 may output pixels to film recorders adapted to reproduce computer generated images on photographic film. Display processor 512 can provide display device 510 with an analog or digital signal. In various embodiments, one or more of the various graphical user interfaces set forth in FIG. 3 are displayed to one or more users via display device 510, and the one or more users can input data into and receive visual output from those various graphical user interfaces.

A system disk 514 is also connected to I/O bridge 507 and may be configured to store content and applications and data for use by CPU 502 and display processor 512. System disk 514 provides non-volatile storage for applications and data and may include fixed or removable hard disk drives, flash memory devices, and CD-ROM, DVD-ROM, Blu-ray, HD-DVD, or other magnetic, optical, or solid state storage devices.

A switch 516 provides connections between I/O bridge 507 and other components such as a network adapter 518 and various add-in cards 520 and 521. Network adapter 518 allows system 500 to communicate with other systems via an electronic communications network, and may include wired or wireless communication over local area networks and wide area networks such as the Internet.

Other components (not shown), including USB or other port connections, film recording devices, and the like, may also be connected to I/O bridge 507. For example, an audio processor may be used to generate analog or digital audio output from instructions and/or data provided by CPU 502, system memory 504, or system disk 514. Communication paths interconnecting the various components in FIG. 5 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 512 incorporates circuitry optimized for graphics and video processing, including, for example, video output circuitry, and constitutes a graphics processing unit (GPU). In another embodiment, display processor 512 incorporates circuitry optimized for general purpose processing. In yet another embodiment, display processor 512 may be integrated with one or more other system elements, such as the memory bridge 505, CPU 502, and I/O bridge 507 to form a system on chip (SoC). In still further embodiments, display processor 512 is omitted and software executed by CPU 502 performs the functions of display processor 512.

Pixel data can be provided to display processor 512 directly from CPU 502. In some embodiments, instructions and/or data representing a scene are provided to a render farm or a set of server computers, each similar to system 500, via network adapter 518 or system disk 514. The render farm generates one or more rendered images of the scene using the provided instructions and/or data. These rendered images may be stored on computer-readable media in a digital format and optionally returned to system 500 for display. Similarly, stereo image pairs processed by display processor 512 may be output to other systems for display, stored in system disk 514, or stored on computer-readable media in a digital format.

Alternatively, CPU 502 provides display processor 512 with data and/or instructions defining the desired output images, from which display processor 512 generates the pixel data of one or more output images, including characterizing and/or adjusting the offset between stereo image pairs. The data and/or instructions defining the desired output images can be stored in system memory 504 or graphics memory within display processor 512. In an embodiment, display processor 512 includes 3D rendering capabilities for generating pixel data for output images from instructions and data defining the geometry, lighting shading, texturing, motion, and/or camera parameters for a scene. Display processor 512 can further include one or more programmable execution units capable of executing shader programs, tone mapping programs, and the like.

Further, in other embodiments, CPU 502 or display processor 512 may be replaced with or supplemented by any technically feasible form of processing device configured process data and execute program code. Such a processing device could be, for example, a central processing unit (CPU), a graphics processing unit (GPU), an application-specific integrated circuit (ASIC), a field-programmable gate array (FPGA), and so forth. In various embodiments any of the operations and/or functions described herein can be performed by CPU 502, display processor 512, or one or more other processing devices or any combination of these different processors.

CPU 502, render farm, and/or display processor 512 can employ any surface or volume rendering technique known in the art to create one or more rendered images from the provided data and instructions, including rasterization, scanline rendering REYES or micropolygon rendering, ray casting, ray tracing, image-based rendering techniques, and/or combinations of these and any other rendering or image processing techniques known in the art.

In other contemplated embodiments, system 500 may be a robot or robotic device and may include CPU 502 and/or other processing units or devices and system memory 504. In such embodiments, system 500 may or may not include other elements shown in FIG. 5. System memory 504 and/or other memory units or devices in system 500 may include instructions that, when executed, cause the robot or robotic device represented by system 500 to perform one or more operations, steps, tasks, or the like.

It will be appreciated that the system shown herein is illustrative and that variations and modifications are possible. The connection topology, including the number and arrangement of bridges, may be modified as desired. For instance, in some embodiments, system memory 504 is connected to CPU 502 directly rather than through a bridge, and other devices communicate with system memory 504 via memory bridge 505 and CPU 502. In other alternative topologies display processor 512 is connected to I/O bridge 507 or directly to CPU 502, rather than to memory bridge 505. In still other embodiments, I/O bridge 507 and memory bridge 505 might be integrated into a single chip. The particular components shown herein are optional; for instance, any number of add-in cards or peripheral devices might be supported. In some embodiments, switch 516 is eliminated, and network adapter 518 and add-in cards 520, 521 connect directly to I/O bridge 507.

In sum, the disclosed techniques set forth an interactive way for users to obtain tailored support while viewing a learning video of a software application. The system allows users to select a specific area within the learning video—such as an icon, menu item, or other recognizable visual component (referred to herein as a “UI element”). The system receives an image of the UI element and compares it against a library of icons, menu items, and visual features known to be part of the software application. This comparison enables the system to accurately identify the UI element within the library, and generate a contextual description that is specific to the software application's interface and functions, thereby providing clarity on the selected UI element without requiring the user to describe the UI element in detail.

After the contextual description is generated, the system pairs the contextual description with the user's question, thereby forming a combined query that can be used to target relevant information. Using this combined query, the system searches a variety of resources, including official documentation, video transcriptions, and related information specific to the software application. In this manner, the support provided can be directly relevant to the specific UI element in question. The system then consolidates essential elements—such as the user's question, the contextual description of the selected area, the relevant documentation, and metadata associated with the learning video (e.g., title, transcript, comments, etc.)—into a comprehensive (i.e., rich) prompt designed for a large language model (LLM). This rich prompt allows the LLM to fully understand the context, interpret the user's question accurately, and then generate a detailed answer. The answer provided by the LLM is informed by the combined data, thereby ensuring that the answer is both specific to the user's question and relevant to the software application. Finally, the answer is delivered to the user, who can view and interact with the response to gain deeper insights.

One technical advantage of the disclosed techniques over the prior art is that the disclosed techniques provide an efficient system for providing automated and contextualized assistance to users when interacting with learning videos. In particular, by enabling the user to select different user interface elements of a software application featured in a learning video—such as icons, menu items, or other visual components—the disclosed techniques can be implemented to identify and interpret the selected user interface elements by looking up the selected elements in a library of known user interface elements that are specific to the software application. This automated recognition allows the system to generate descriptions of the selected user interface elements that are contextualized to the software application.

In addition, once the system has generated the contextualized descriptions, the system can pair the contextualized description with one or more questions input by the user. Once paired, the disclosed techniques enable a wide array of internal and external resources, such as documentation, transcriptions of learning videos, and related knowledge bases, to be searched for relevant information. This automated linking of contextualized descriptions and questions to specific resources helps ensure that users receive relevant guidance that is directly applicable to the questions asked. Further, with the disclosed techniques, relevant responses and information can be returned to users more immediately relative to what can be achieved using prior art approaches, thereby facilitating a more real-time learning experience for users.

Yet another technical advantage is that the disclosed techniques enable scaling to accommodate a high volume of queries, thereby enabling a more personalized support experience for all users relative to what is typically experienced with prior art approaches. Moreover, by enabling the libraries of icons, menu items, and other visual elements associated with a software application to be continuously updated, the disclosed techniques allow a video tutorial platform to remain current with any changes that are made to software applications over time, thereby enabling the platform to maintain ongoing relevance and accuracy when providing answers to questions.
1. In some embodiments, a computer-implemented method for generating answers to user questions about a software application that is featured in a learning video comprises generating at least one description based on at least one image-based input associated with the learning video; generating a combined value based on the at least one description and a text-based question; obtaining a plurality of articles based on the combined value; generating, via at least one generative artificial intelligence (AI) model, an answer to the text-based question based on the plurality of articles; and causing at least a portion of the answer to be output via at least one user interface.
2. The computer-implemented method of clause 1, wherein: the at least one description is generated based on the at least one image-based input by performing at least one of an optical character recognition operation, an image captioning operation, or a user interface element detection operation.
3. The computer-implemented method of clause 1, further comprising, prior to obtaining the plurality of articles based on the combined value, generating a first plurality of embeddings for a first article included in the plurality of articles.
4. The computer-implemented method of clause 1, further comprising, prior to generating the answer to the text-based question based on the plurality of articles: generating, based on the combined value, similarity scores for the plurality of articles; identifying, among the plurality of articles, a subset of articles having similarity scores that do not satisfy a threshold value; and removing the subset of articles from the plurality of articles.
5. The computer-implemented method of clause 1, wherein the answer to the text-based question is further based on metadata associated with the learning video, wherein the metadata comprises at least one of a title of the learning video or at least a portion of a transcript of the learning video.
6. The computer-implemented method of clause 5, further comprising: identifying a current timestamp associated with a playback of the learning video; identifying at least one transcript sentence of the learning video that corresponds to the current timestamp; and generating the at least a portion of the transcript based on the at least one transcript sentence.
7. The computer-implemented method of clause 1, further comprising, prior to generating the at least one description based on the at least one image-based input: receiving, via the at least one user interface, a bounding box selection of a video frame included in the learning video; and generating the at least one image-based input based on the bounding box selection and the video frame.
8. The computer-implemented method of clause 1, further comprising: receiving or generating a name for a bounding box selection of a video frame included in the learning video; and generating, within the at least one user interface, a user interface element that is based on the name and the bounding box selection, wherein the user interface element, when selected, causes the name to be populated into a textbox user interface element that is included in the at least one user interface and into which text-based questions can be input.
9. The computer-implemented method of clause 1, wherein the answer comprises at least one of text-based information, audio information, visual information, or executable code.
10. The computer-implemented method of clause 9, further comprising causing at least one of the software application or at least one different software application to execute the executable code.
11. In some embodiments, one or more non-transitory computer readable media include instructions that, when executed by one or more processors, cause the one or more processors to generate answers to user questions about a software application that is featured in a learning video, by performing the operations of: generating at least one description based on at least one image-based input associated with the learning video; generating a combined value based on the at least one description and a text-based question; obtaining a plurality of articles based on the combined value; generating, via at least one generative artificial intelligence (AI) model, an answer to the text-based question based on the plurality of articles; and causing at least a portion of the answer to be output via at least one user interface.
12. The one or more non-transitory computer readable media of clause 11, wherein: the at least one description is generated based on the at least one image-based input by performing at least one of an optical character recognition operation, an image captioning operation, or a user interface element detection operation.
13. The one or more non-transitory computer readable media of clause 11, further comprising, prior to obtaining the plurality of articles based on the combined value, generating a first plurality of embeddings for a first article included in the plurality of articles.
14. The one or more non-transitory computer readable media of clause 11, further comprising, prior to generating the answer to the text-based question based on the plurality of articles: generating, based on the combined value, similarity scores for the plurality of articles; identifying, among the plurality of articles, a subset of articles having similarity scores that do not satisfy a threshold value; and removing the subset of articles from the plurality of articles.
15. The one or more non-transitory computer readable media of clause 11, wherein the answer to the text-based question is further based on metadata associated with the learning video, wherein the metadata comprises at least one of a title of the learning video or at least a portion of a transcript of the learning video.
16. The one or more non-transitory computer readable media of clause 15, further comprising: identifying a current timestamp associated with a playback of the learning video; identifying at least one transcript sentence of the learning video that corresponds to the current timestamp; and generating the at least a portion of the transcript based on the at least one transcript sentence.
17. The one or more non-transitory computer readable media of clause 11, further comprising, prior to generating the combined value based on the at least one description and the text-based question: receiving at least one audio input; and generating the text-based question based on the at least one audio input.
18. The one or more non-transitory computer readable media of clause 11, further comprising: receiving feedback information associated with the at least a portion of the answer; and updating the at least one generative AI model based on the feedback information.
19. The one or more non-transitory computer readable media of clause 11, further comprising: monitoring at least one aspect of a utilization of the software application; generating, via the at least one generative AI model, an alignment score that indicates an adherence to the answer, wherein the alignment score is based on the at least one aspect; and generating at least one user interface element within the at least one user interface that reflects the alignment score.
20. In some embodiments, a computer system comprises one or more memories that include instructions, and one or more processors that are coupled to the one or more memories, and, when executing the instructions, are configured to perform the operations of: generating at least one description based on at least one image-based input associated with a learning video; generating a combined value based on the at least one description and a text-based question; obtaining a plurality of articles based on the combined value; generating, via at least one generative artificial intelligence (AI) model, an answer to the text-based question based on the plurality of articles; and causing at least a portion of the answer to be output via at least one user interface.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention has been described above with reference to specific embodiments. Persons of ordinary skill in the art, however, will understand that various modifications and changes may be made thereto without departing from the broader spirit and scope of the invention as set forth in the appended claims. For example, and without limitation, although many of the descriptions herein refer to specific types of I/O devices that may acquire data associated with an object of interest, persons skilled in the art will appreciate that the systems and techniques described herein are applicable to other types of I/O devices. The foregoing description and drawings are, accordingly, to be regarded in an illustrative rather than a restrictive sense.

While the preceding is directed to embodiments of the present disclosure, other and further embodiments of the disclosure may be devised without departing from the basic scope thereof, and the scope thereof is determined by the claims that follow.

What is claimed is:

1. A method for generating answers to user questions about a software application that is featured in a learning video, the method comprising:
generating at least one description based on at least one image-based input associated with the learning video;
generating a combined value based on the at least one description and a text-based question;
obtaining a plurality of articles based on the combined value;
generating, via at least one generative artificial intelligence (AI) model, an answer to the text-based question based on the plurality of articles; and
causing at least a portion of the answer to be output via at least one user interface.

2. The computer-implemented method of claim 1, wherein:
the at least one description is generated based on the at least one image-based input by performing at least one of an optical character recognition operation, an image captioning operation, or a user interface element detection operation.

3. The computer-implemented method of claim 1, further comprising, prior to obtaining the plurality of articles based on the combined value, generating a first plurality of embeddings for a first article included in the plurality of articles.

4. The computer-implemented method of claim 1, further comprising, prior to generating the answer to the text-based question based on the plurality of articles:
generating, based on the combined value, similarity scores for the plurality of articles;
identifying, among the plurality of articles, a subset of articles having similarity scores that do not satisfy a threshold value; and
removing the subset of articles from the plurality of articles.

5. The computer-implemented method of claim 1, wherein the answer to the text-based question is further based on metadata associated with the learning video, wherein the metadata comprises at least one of a title of the learning video or at least a portion of a transcript of the learning video.

6. The computer-implemented method of claim 5, further comprising:
identifying a current timestamp associated with a playback of the learning video;
identifying at least one transcript sentence of the learning video that corresponds to the current timestamp; and
generating the at least a portion of the transcript based on the at least one transcript sentence.

7. The computer-implemented method of claim 1, further comprising, prior to generating the at least one description based on the at least one image-based input:
receiving, via the at least one user interface, a bounding box selection of a video frame included in the learning video; and
generating the at least one image-based input based on the bounding box selection and the video frame.

8. The computer-implemented method of claim 1, further comprising:
receiving or generating a name for a bounding box selection of a video frame included in the learning video; and
generating, within the at least one user interface, a user interface element that is based on the name and the bounding box selection, wherein the user interface element, when selected, causes the name to be populated into a textbox user interface element that is included in the at least one user interface and into which text-based questions can be input.

9. The computer-implemented method of claim 1, wherein the answer comprises at least one of text-based information, audio information, visual information, or executable code.

10. The computer-implemented method of claim 9, further comprising causing at least one of the software application or at least one different software application to execute the executable code.

11. One or more non-transitory computer readable media storing instructions that, when executed by one or more processors, cause the one or more processors to generate answers to user questions about a software application that is featured in a learning video, by performing the operations of:
generating at least one description based on at least one image-based input associated with the learning video;
generating a combined value based on the at least one description and a text-based question;
obtaining a plurality of articles based on the combined value;
generating, via at least one generative artificial intelligence (AI) model, an answer to the text-based question based on the plurality of articles; and
causing at least a portion of the answer to be output via at least one user interface.

12. The one or more non-transitory computer readable media of claim 11, wherein:
the at least one description is generated based on the at least one image-based input by performing at least one of an optical character recognition operation, an image captioning operation, or a user interface element detection operation.

13. The one or more non-transitory computer readable media of claim 11, further comprising, prior to obtaining the plurality of articles based on the combined value, generating a first plurality of embeddings for a first article included in the plurality of articles.

14. The one or more non-transitory computer readable media of claim 11, further comprising, prior to generating the answer to the text-based question based on the plurality of articles:
generating, based on the combined value, similarity scores for the plurality of articles;
identifying, among the plurality of articles, a subset of articles having similarity scores that do not satisfy a threshold value; and
removing the subset of articles from the plurality of articles.

15. The one or more non-transitory computer readable media of claim 11, wherein the answer to the text-based question is further based on metadata associated with the learning video, wherein the metadata comprises at least one of a title of the learning video or at least a portion of a transcript of the learning video.

16. The one or more non-transitory computer readable media of claim 15, further comprising:
identifying a current timestamp associated with a playback of the learning video;
identifying at least one transcript sentence of the learning video that corresponds to the current timestamp; and
generating the at least a portion of the transcript based on the at least one transcript sentence.

17. The one or more non-transitory computer readable media of claim 11, further comprising, prior to generating the combined value based on the at least one description and the text-based question:
receiving at least one audio input; and
generating the text-based question based on the at least one audio input.

18. The one or more non-transitory computer readable media of claim 11, further comprising:
receiving feedback information associated with the at least a portion of the answer; and
updating the at least one generative AI model based on the feedback information.

19. The one or more non-transitory computer readable media of claim 11, further comprising:
monitoring at least one aspect of a utilization of the software application;
generating, via the at least one generative AI model, an alignment score that indicates an adherence to the answer, wherein the alignment score is based on the at least one aspect; and
generating at least one user interface element within the at least one user interface that reflects the alignment score.

20. A computer system, comprising:
one or more memories that include instructions; and
one or more processors that are coupled to the one or more memories and, when executing the instructions, are configured to perform the operations of:
generating at least one description based on at least one image-based input associated with a learning video;
generating a combined value based on the at least one description and a text-based question;
obtaining a plurality of articles based on the combined value;
generating, via at least one generative artificial intelligence (AI) model, an answer to the text-based question based on the plurality of articles; and
causing at least a portion of the answer to be output via at least one user interface.
